(19) United States
(12) Patent Application Publication
(10) Pub. No.: US 2005/0235089 A1
(43) Pub. Date: Oct. 20, 2005

(54) Method and apparatus for universal serial bus (USB) physical layer

(76) Inventors: Fred Cheng, Hsinchu (TW); Chen-Min Chiang, Hsinchu (TW); Jenn-Shiang Lai, Chung Li City (TW); San Lin, Fremont, CA (US); Jingyu Hu, Fremont, CA (US); Aung Myint Oo, Fremont, CA (US); Zhihui Luo, Fremont, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,423

(22) Filed: Mar. 29, 2005

(30) Foreign Application Priority Data
Apr. 2, 2004 (TW) 93109305

(51) Int. Cl. G06F 13/00

(52) U.S. Cl. 710/305

(57) ABSTRACT

The present invention relates to a method and apparatus universal serial bus (USB) physical layer. An UTM interface control logic receives a transmit data packet of USB 2.0 transceiver macrocell interface (UTMI). A transmit first-in first-out (FIFO) unit receives the transmit data packet output from the UTM interface control logic. A transmit unit receives the transmit data packet output from the transmit FIFO. An analog front-end (AFE) receives the transmitted data packet output of the transmit unit. A receive unit receives a receive data packet output from the AFE. A receive FIFO receives the receive data packet output from the receive unit and connected to the UTM interface control logic, whereby the receive data packet is output to the USB 2.0 transceiver macrocell interface.

### BACKGROUND OF THE INVENTION

1. Field of the Invention

The present invention relates to a method and apparatus for a universal serial bus (USB) physical layer, and more particularly relates to an apparatus to add a queue circuit (First-in First-out, FIFO) and remove a elasticity buffer apparatus on the USB 2.0 physical layer, and the data transmit and receive method on the apparatus.

2. Description of Related Art

Universal Serial Bus (USB) interfaces are currently implemented on personal computer peripheral equipment. The USB interface has many useful features: low cost, hot-plugging and a transmission line power supply. The USB apparatus does not occupy memory, input/output address, direct memory access (DMA) channel or interrupt request (IRQ) line, and execution of a USB also includes an error detect mechanism. These features solve many disadvantages of traditional PC peripheral equipment.

Full-speed USB apparatus operation frequency is 12 Mbps on USB 1.1. When the signal increased to 480 MHz on USB 2.0, using the traditional method to implement a full-speed USB apparatus is very difficult. Intel Corporation has promoted development of USB 2.0 peripheral equipment apparatus, and hence offers USB 2.0 transceiver macrocell interface (UTMI).

The USB 2.0 transmission standard interface processes low-level USB protocol and signal, such as data serialize and de-serialize. It was designed to allow a single interface control unit to use USB transceivers of various speeds.

FIG. 1 is a schematic diagram of the USB transceiver/receiver circuit of the prior art. Elements thereof include a transmit hold register 10, a transmit shift register 12, a bit stuffer 14, a non-return-to-zero inverted encoder 16, an external oscillator 20, a clock multiplier 22, a control logical 24, an analog front-end 18, a full-speed delay phase locked loop and data recovery 26, a high-speed phase locked loop 28, a elasticity buffer 30, a multiplexer 32, a non-return-to-zero inverted decoder unit 38, a bit unstuffer 40, a receive shift register 42, a receive hold register 44, a transmit states machine 36, and a receive state machine 34.

The analog front-end unit 18 further comprises a high-speed transceiver unit 182 and a full-speed transceiver unit 180. The fill-speed transceiver unit 180 further comprises a receiver 1804, a status/control unit 1802 and a transmitter 1800. The high-speed transceiver unit 182 further comprises a receiver 1824, a status/control unit 1822 and a transmitter 1820.

The operation method of the traditional USB 2.0 transmit/receive unit transmits the transmit data packet 46 from the input of the USB 2.0 transceiver macrocell interface (UTMI) to the transmit hold register 10 and the transmit shift register 12, then queues and serializes the transmit data packet 46. The transmit data packet 46 is processed and combined into a bit stream in the bit stuffer 14 and in the non-return-to-zero inverted encoder 16. The serial data packet is sent to transmitter 1800 of the full-speed transceiver unit 180 of the analog front-end unit 18 or transmitter 1820 of the high-speed transceiver unit 182 of the analog front-end unit 18.

Conversely, the receive data packet is output from the receiver 1824 of the high-speed transceiver unit 182 of the analog front-end unit 18 to the high-speed delay phase locked loop 28 and the elasticity buffer 30, or the receive data packet is output from the receiver 1804 of the full-speed transceiver unit 180 of the analog front-end unit 18 to the full-speed delay phase locked loop and data recovery 26. The data packet of the elasticity buffer 30 is received and synchronized and the data packet of the full-speed delay phase locked loop and data recovery 26 is output to the multiplexer 32. The data packet is sent after synchronization to the non-return-to-zero inverted decoder 38 and decoded. The data packet is transmitted after being decoded to the bit unstuffer 40. The data packet (de-serialize) enters the receive shift register 42 and receive hold register 44 after decoded information. The receive data packet 48 is output to the USB 2.0 transceiver macrocell interface.

The disadvantage of the prior art is the irregular internal clock and complicated circuit design, as well as the addition of a flexible buffer to the circuit. The receive data packet in the receiver thus easily generates overflow and underflow.

### SUMMARY OF THE INVENTION

The present invention relates to a method and apparatus for a universal serial bus (USB) physical layer. An interface control unit receives a transmit data packet of USB 2.0 transceiver macrocell interface (UTMI). A transmit first-in first-out (FIFO) unit receives the transmit data packet output of the interface control unit. A transmit unit receives the transmit data packet output of the transmit first-in first-out unit. An analog front-end unit receives the transmit data packet output of the transmit unit. A receive unit receives a receive data packet output from the analog front-end unit. A receive first-in first-out (FIFO) unit receives the receive data packet output from the receive unit and connected to the interface control unit, whereby the receive data packet is output to the USB 2.0 transceiver macrocell interface. The present invention also uses the transmit and receive method for an apparatus of the USB physical layer. The present invention is used to resolve flexible buffer overflow and underflow problems, while the circuit is simple, and thus cheap.

### BRIEF DESCRIPTION OF THE DRAWINGS

The various objects and advantages of the present invention will be more readily understood from the following detailed description when read in conjunction with the appended drawing, in which:

FIG. 1 is a schematic diagram of the USB transceiver/receiver circuit of the prior art;

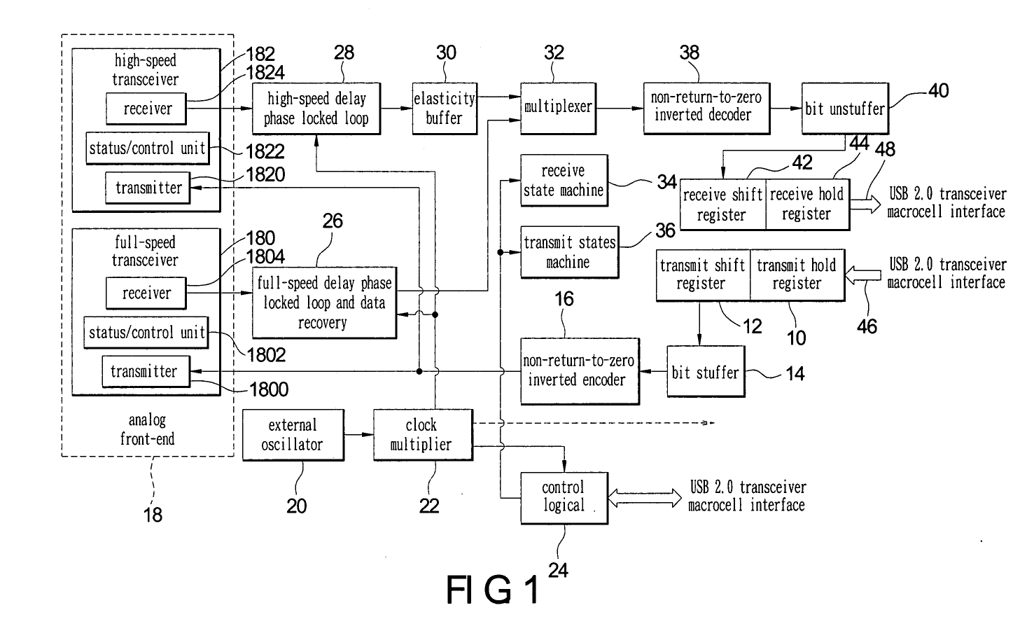

FIG. 2 is a schematic diagram of the USB physical layer of the present invention;

FIG. 3 is an internal schematic diagram of the USB physical layer of the present invention;

FIG. 4 is a flowchart of the transmit method of the USB physical layer of the present invention; and

FIG. 5 is a flowchart of the receive method of the USB physical layer of the present invention.

### DETAILED DESCRIPTION OF PREFERRED EMBODIMENTS

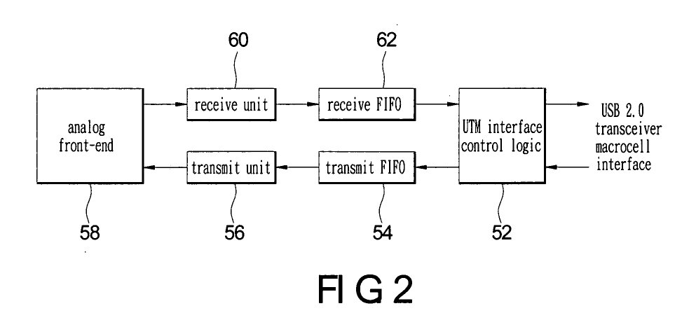

FIG. 2 shows a schematic diagram of the USB physical layer apparatus of the present invention, which comprises an UTM interface control logic 52 and receives a transmit data packet from an USB 2.0 transceiver macrocell interface (UTMI). A transmit FIFO (first-in first-out) 54 receives an input signal output of the UTM interface control logic 52. A transmit unit 56 receives the transmit data packet output from the transmit FIFO 54. An analog front-end 58 receives the transmit data packet output of the transmit unit 56. A receive unit 60 receives a received data packet output from the analog front-end 58. A receive FIFO 62 receives the receive data packet output of the receive unit 60 and is connected to the UTM interface control logic 52. The received data packet is output to the USB 2.0 transceiver macrocell interface.

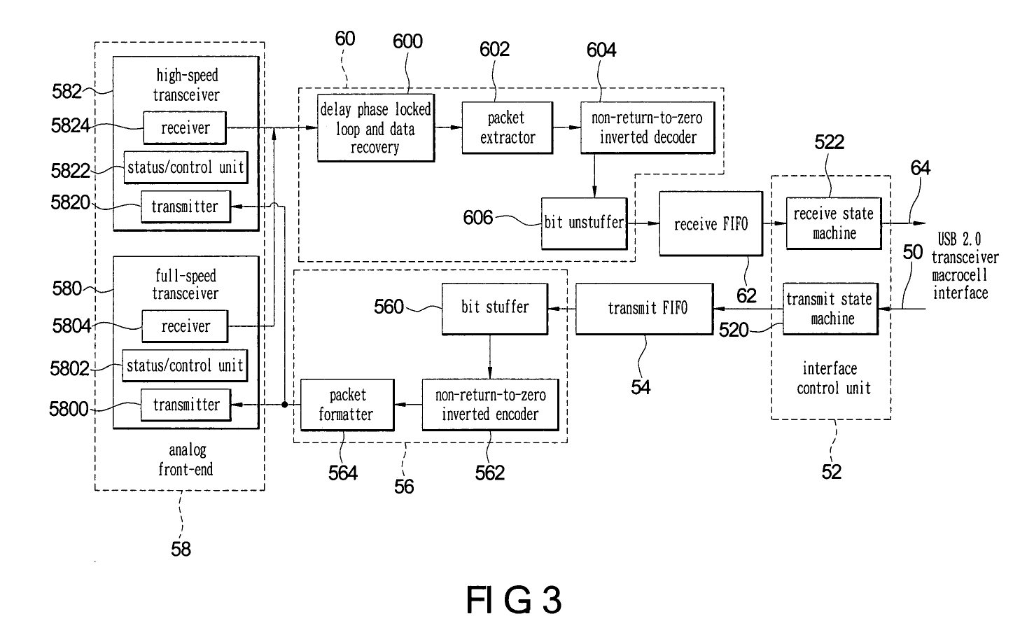

FIG. 3 is an internal schematic diagram of the USB physical layer of the present invention, which comprises an UTM interface control logic 52, which further comprises a receive state machine 522 and a transmit state machine 520. The transmit state machine 520 of the UTM interface control logic 52 receives a transmit data packet 50 input from the USB 2.0 transceiver macrocell interface and a transmit FIFO 54, which receives the transmit data packet 50 output from the UTM interface control logic. The transmit unit 56 further comprises a bit stuffer 560 connected to the transmit FIFO transmit FIFO 54, a non-return-to-zero inverted encoder 562 connected to the bit stuffer 560, and a packet formatter 564 connected to the non-return-to-zero inverted encoder 562 and the analog front-end 58.

An analog front-end 58 receives the transmit data packet 50 output from the transmit unit 56. The analog front-end 58 further comprises a high-speed transceiver 582 and a full-speed transceiver 580. The full-speed transceiver 580 further comprises a receiver 5804, a status/control unit 5802 and a transmitter 5800. The high-speed transceiver 582 further comprises a receiver 5824, a status/control unit 5822 and a transmitter 5820.

A receive unit 60 receives a received data packet output from the analog front-end 58. The receive unit 60 further comprises a delay phase locked loop and data recovery 600 connected to the analog front-end 58, a packet extractor 602 connected to the delay phase locked loop and data recovery 600, a bit unstuffer 606 connected to non-return-to-zero inverted decoder 604, and a receive FIFO 62, which receives the receive data packet output of the receive unit 60 and connected to the state machine 522 of the UTM interface control logic 52. The received data packet 64 is transmitted to the USB 2.0 transceiver macrocell interface.

The operate method of the USB physical layer of the present invention inputs a transmitted data packet 50 from a USB 2.0 transceiver macrocell interface to the transmit state machine 520 of the UTM interface control logic 52. The transmit state machine 520 will generate a synchronization pattern inside the data packet and control a data stream input into the transmit FIFO 54. The bit stuffer 560 will add one bit of logic zero after six continuous bits of logic one are inside the data packet. The non-return-to-zero inverted encoder 562 will encode the data packet. The data stream is transmitted after encode to the packet formatter 564 and an end of packet for each packet is added from the data stream.

The data packet is transmitted from the analog front-end 58 to the packet extractor 602. A synchronization pattern and an end of packet format of the data packet are received. The data packet is input into the non-return-to-zero inverted decoder 604 and the bit unstuffer 606 to restore a real data packet. The data packet is transmitted to the receive FIFO62 and ordered in the receive state machine 522. The data packet is reconstructed and a receive data 64 is transmitted to the USB 2.0 transceiver macrocell interface.

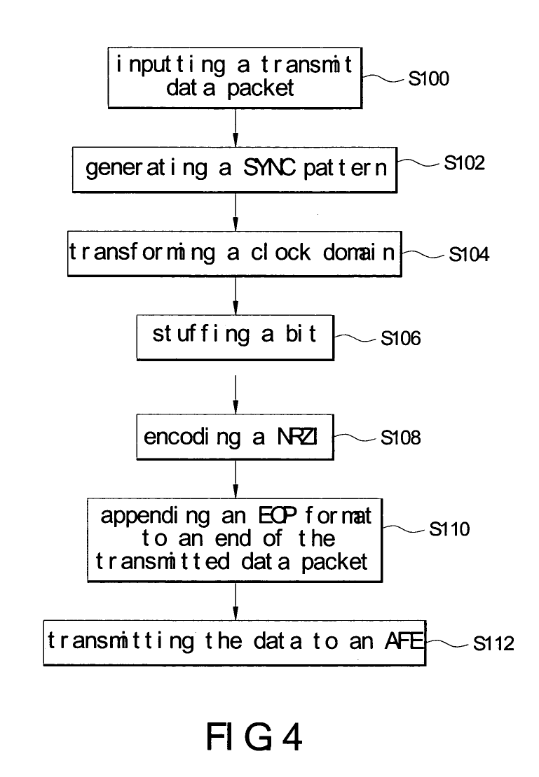

FIG. 4 is a flowchart of the transmit method of the USB physical layer according to the invention, which comprises the steps of inputting a transmitted data packet (S100), generating a SYNC pattern (S102). The S102 means generate a synchronization pattern to add the head of the transmit data packet. Transforming a clock domain (S104) is means queue the transmit data packet after adding the synchronization pattern and transferring clock time. The queue can change the transmit data packet to another clock domain, and stuffing a bit (S106) is means stuff a bit into the transmit data packet. The step of stuffing a bit which is added to one bit of logic zero after six continuous bits of logic one in the transmit data packet, encoding a NRZI (S108) is means encode a non-return-to-zero to the transmit data packet, in which the step of the non-return-to-zero to the transmit data packet changes the output value when the input bit is zero, and does not change the output value when the current bit is one, appending an EOP format to an end of the transmitted data packet (S110), and transmitting the data to an AFE (S112).

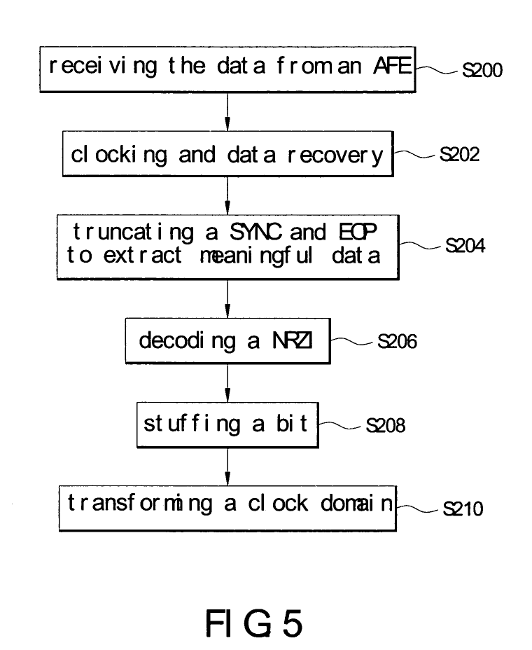

FIG. 5 is a flowchart of the receive method of the USB physical layer according to this invention, which comprises the steps of receiving the data from an AFE (S200), clocking and data recovery (S202) is means separate a data packet and a clock packet of the data packet, truncating a SYNC and EOP to extract meaningful data (S204), decoding a NRZI (S206), stuffing a bit (S208), transforming a clock domain (S210), and sending the actual data packet to UTMI (S212). Step S204 of truncating the SYNC and EOP also can be executed to truncate the SYNC and EOP in step S210.

The method and apparatus for the universal serial bus physical layer of the present invention resolves flexible buffer overflow or underflow and the circuit is simple, and thus cheap.

Although the present invention has been described with reference to the preferred embodiment thereof, it will be understood that the invention is not limited to the details thereof. Various substitutions and modifications have suggested in the foregoing description, and others will occur to those of ordinary skill in the art. Therefore, all such substitutions and modifications are intended to be embraced within the scope of the invention as defined in the appended claims.

1. An apparatus of a universal serial bus physical layer, comprising:
an UTM interface control logic, wherein the UTM interface control logic receives a transmit data packet of USB 2.0 transceiver macrocell interface (UTMI);
a transmit FIFO, wherein the transmit FIFO receives the transmit data packet output from the interface control unit;
a transmit unit, wherein the transmit unit receives the transmit data packet output from the transmit first-in first-out unit;
an analog front-end unit, wherein the analog front-end unit receives the transmitted data packet output from the transmit unit;
a receive unit, wherein the receive unit receives a receive data packet output from the analog front-end unit; and
a receive FIFO, wherein the FIFO receives the receive data packet output of the receive unit and connects to the UTM interface control logic, and the receive data packet is output to the USB 2.0 transceiver macrocell interface.

2. The apparatus of universal serial bus physical layer as in claim 1, wherein the UTM interface control logic further comprises a receive state machine and a transmit state machine.

3. The apparatus of universal serial bus physical layer as in claim 1, wherein the transmit unit further comprises:
a bit stuffer connected to the transmit FIFO;
a non-return-to-zero inverted (nrzi) encoder connected to the bit stuffer; and
a packet formatter connected to the non-return-to-zero inverted (NRZI) decoder and the analog front-end.

4. The apparatus of universal serial bus physical layer as in claim 1, wherein the receive unit further comprises:
a delay phase locked loop and data recovery connected to the analog front-end;
a packet extractor connected to the delay lock loop line and data recovery;
a non-return-to-zero inverted decoder connected to the packet extractor; and
a bit stuffer connected to the non-return-to-zero inverted decoder and the receive FIFO.

5. A transmit method of a universal serial bus physical layer, wherein the method comprises:
inputting a transmit data packet;
generating a SYNC;
transforming a clock domain;
stuffing a bit;
encoding a NRZI;
appending an EOP format to an end of the transmitted data packet; and
transmitting the data to an AFE.

6. The transmit method of the universal serial bus physical layer as in claim 5, wherein the step of transforming a clock domain is changed the transmit data packet to another clock domain.

7. The transmit method of the universal serial bus physical layer as in claim 5, wherein the step of stuffing a bit which is added to one bit of logic zero after six continuous bits of logic one in the transmit data packet.

8. The transmit method of the universal serial bus physical layer as in claim 5, wherein the step of encoding a NRZI is compare an input bit with a content of the transmit data packet.

9. The transmit method of the universal serial bus physical layer as in claim 8, wherein a comparison result changes the output bit value when a zero bit is input, and does not change the output bit value when a one bit is input.

10. A receive method of the universal serial bus physical layer comprises:
receiving the data from an AFE;
clocking and data recovery;
truncating a SYNC and EOP to extract meaningful data
decoding a NRZI;
stuffing a bit;
transforming a clock domain; and
sending the actual data packet to UTMI.

11. The receive method of the universal serial bus physical layer as in claim 10, wherein in the step of truncating a SYNC and EOP to extract meaningful data, the SYNC and EOP is truncated before actual transmission of the data packet.
